(19) United States
(12) Patent Application Publication
(10) Pub. No.: US 2014/0012791 A1
(43) Pub. Date: Jan. 9, 2014

(54) SYSTEMS AND METHODS FOR SENSOR ERROR DETECTION AND COMPENSATION

(71) Applicants: Anthony James GRICHNIK, Eureka, IL (US); Rachel Lau YAGER, New York, NY (US); Ronald Robert YAGER, New York, NY (US)

(72) Inventors: Anthony James GRICHNIK, Eureka, IL (US); Rachel Lau YAGER, New York, NY (US); Ronald Robert YAGER, New York, NY (US)

(73) Assignee: Caterpillar Inc.

(21) Appl. No.: 13/541,911

(22) Filed: Jul. 5, 2012

(51) Int. Cl. G06F 17/18; G06N 5/02; G06F 15/00

(52) U.S. Cl. 706/46; 702/183; 702/179; 702/24

(57) ABSTRACT

A sensor error detection and compensation system is disclosed. The system may have a sensor state estimation module that is configured to generate a physical sensor confidence value representing an accuracy estimation of a physical sensor output value received from a physical sensor. The system may also have a sensor output aggregation module configured to determine an aggregated sensor value based on the physical sensor confidence value, the physical sensor output value, a virtual sensor output value received from a virtual sensor, and a virtual sensor confidence value representing an accuracy estimation of the virtual sensor output value. Moreover, the system may have a replace sensor decision module configured to determine whether the physical sensor has failed by comparing the physical sensor confidence value to a replacement threshold level.

### TECHNICAL FIELD

This disclosure relates generally to physical and virtual sensor techniques and, more particularly, to detecting and compensating for physical sensor errors.

### BACKGROUND

Physical sensors are used in many modern machines to measure and monitor physical phenomena, such as emissions, temperature, speed, and fluid flow constituents. Physical sensors often take direct measurements of the physical phenomena and convert these measurements into measurement data to be further processed by control systems. Although physical sensors take direct measurements of the physical phenomena, they may deteriorate over time and/or otherwise produce unreliable or incorrect values. When control systems rely on physical sensors to operate properly, a failure of a physical sensor may render such control systems inoperable. For example, an unreliable Nitrogen Oxide (NOₓ) sensor may cause a control system to over- or under-dose an aftertreatment system used to control emissions output. Moreover, the physical sensors may fail soft, meaning that they produce erroneous readings that fall within the range of valid measurements. Such errors may be particularly difficult to identify.

Instead of direct measurements, virtual sensors may process other physically measured values to produce values that were measured directly by physical sensors. The virtual sensor outputs may be used by the control systems to control the machine and/or may be used to assess the functionality of the physical sensor. For example, U.S. Pat. No. 5,539,638 (the '638 patent) issued to Keeler et al. on Jul. 23, 1996, discloses a system for monitoring emissions that includes both a physical emissions sensor and a predictive model that predicts an emissions value output by the physical sensor based on other input values. The physical sensor output may be compared to the predicted output and, if the values differ, the representation of the engine used by the predictive model may be adjusted.

The techniques disclosed in the '638 patent may not account for certain limitations of the virtual sensor environment and/or the physical sensor it is replacing, and thus may provide inaccurate values. Moreover, the techniques disclosed in the '638 patent may not be able to accurately detect a fail soft error in a physical sensor or simultaneously detect and compensate for the error.

The disclosed methods and systems are directed to solving one or more of the problems set forth above and/or other problems of the prior art.

### SUMMARY

In one aspect, the present disclosure is directed to a sensor error detection and compensation system. The system may include a sensor state estimation module that is configured to generate a physical sensor confidence value representing an accuracy estimation of a physical sensor output value received from a physical sensor. The system may also have a sensor output aggregation module configured to determine an aggregated sensor value based on the physical sensor confidence value, the physical sensor output value, a virtual sensor output value received from a virtual sensor, and a virtual sensor confidence value representing an accuracy estimation of the virtual sensor output value. Moreover, the system may have a “replace sensor” decision module configured to determine whether the physical sensor has failed by comparing the physical sensor confidence value to a replacement threshold level.

In another aspect, the present disclosure is directed to another sensor error detection and compensation system. The system may include a memory that stores instructions. The system may also include a processor that is configured to execute the instructions to generate a physical sensor confidence value representing an accuracy estimation of a physical sensor output value received from a physical sensor, and determine an aggregated sensor value based on the physical sensor confidence value, the physical sensor output value, a virtual sensor output value received from a virtual sensor, and a virtual sensor confidence value representing an accuracy estimation of the virtual sensor output value. The processor may be further configured to determine whether the physical sensor has failed by comparing the physical sensor confidence value to a replacement threshold level, and output the aggregated sensor value and an indication of whether the physical sensor has failed to a control system of a machine.

In yet another aspect, the present disclosure is directed to a sensor error detection and compensation method. The method may include generating a physical sensor confidence value representing an accuracy estimation of a physical sensor output value received from a physical sensor, and determining an aggregated sensor value based on the physical sensor confidence value, the physical sensor output value, a virtual sensor output value received from a virtual sensor, and a virtual sensor confidence value representing an accuracy estimation of the virtual sensor output value. The method may also include determining whether the physical sensor has failed by comparing the physical sensor confidence value to a replacement threshold level, and outputting the aggregated sensor value and an indication of whether the physical sensor has failed to a control system of a machine.

### BRIEF DESCRIPTION OF THE DRAWINGS

FIG. 1 is a diagrammatic illustration of an exemplary disclosed machine;

FIG. 2 is a block diagram of a exemplary computer system that may be incorporated into the machine of FIG. 1;

FIG. 3A is a block diagram of an exemplary virtual sensor network system that may be incorporated into the machine of FIG. 1;

FIG. 3B is a block diagram of an exemplary virtual sensor that may be incorporated into the machine of FIG. 1;

FIG. 4 is a block diagram of an exemplary sensor error detection and compensation system that may be incorporated into the machine of FIG. 1;

FIG. 5 is a graph illustrating an exemplary relationship between a current physical sensor confidence value β and a current weighted average D(i);

FIG. 6 is includes several graphs illustrate three scenarios for determining a sensor reading difference value Δ(i); and

FIG. 7 is a flow chart illustrating an exemplary process that may be performed by an exemplary sensor error detection and compensation system that may be incorporated into the machine of FIG. 1.

### DETAILED DESCRIPTION

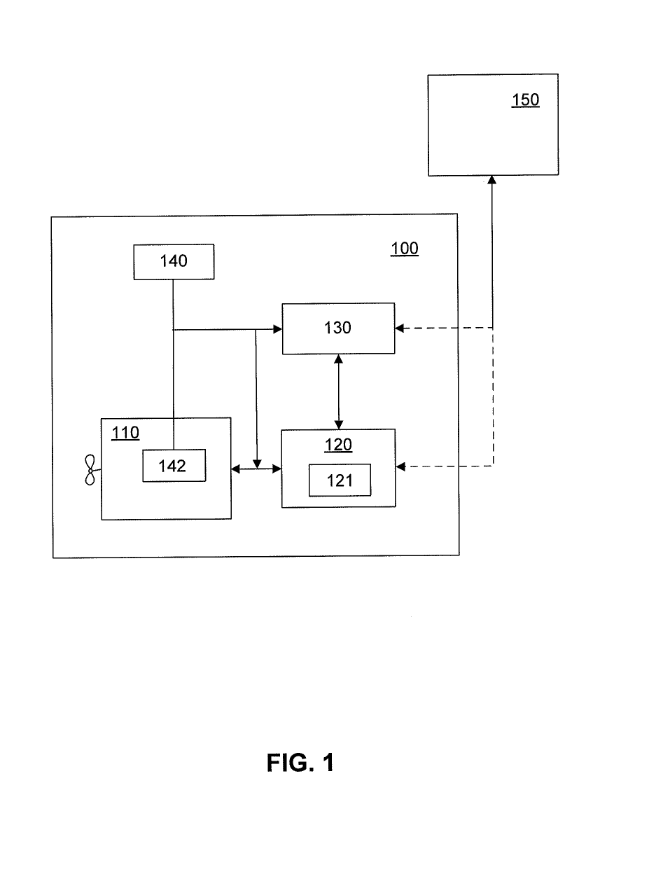

FIG. 1 illustrates an exemplary machine 100 in which features and principles consistent with certain disclosed embodiments may be incorporated. Machine 100 may refer to any type of stationary or mobile machine that performs some type of operation associated with a particular industry, e.g., construction, transportation, etc. Machine 100 may also include any type of commercial vehicle such as cars, vans, and other vehicles. Other types of machines may also be included.

As shown in FIG. 1, machine 100 may include an engine 110, an electronic control module (ECM) 120, a virtual sensor network system 130, and physical sensors 140 and 142. Engine 110 may include any appropriate type of engine or power source that generates power for machine 100, such as an internal combustion engine or fuel cell generator. ECM 120 may include any appropriate type of engine control system configured to perform engine control functions such that engine 110 may operate properly. ECM 120 may include any number of devices, such as microprocessors or microcontrollers, application-specific integrated circuits (ASICs), field programmable gate arrays (FPGAs), memory modules, communication devices, input/output devices, storages devices, etc., to perform such control functions. Further, computer software instructions may be stored in or loaded to ECM 120. ECM 120 may execute the computer software instructions to perform various control functions and processes.

ECM 120 may also include a sensor error detection and compensation system 121, which is explained in greater detail below. Sensor error detection and compensation system 121 may be configured to generate a physical sensor confidence value representing an accuracy estimation of a physical sensor output value received from a physical sensor, determine an aggregated sensor value based on the physical sensor confidence value, the physical sensor output value, a virtual sensor output value received from a virtual sensor, and a virtual sensor confidence value representing an accuracy estimation of the virtual sensor output value; determine whether the physical sensor has failed by comparing the physical sensor confidence value to a replacement threshold level; and send the aggregated sensor value and an indication of whether the physical sensor has failed to a control system of a machine

Although ECM 120 is shown to control engine 110, ECM 120 may also control other systems of machine 100, such as transmission systems and/or hydraulics systems. Multiple ECMs may be included in ECM 120 or may be used on machine 100. For example, a plurality of ECMs may be used to control different systems of machine 100 and also to coordinate operations of these systems. Further, the plurality of ECMs may be coupled together via a communication network to exchange information. Information such as input parameters, output parameters, parameter values, status of control systems, physical and virtual sensors, and virtual sensor networks may be communicated to the plurality of ECMs simultaneously.

Physical sensor 140 may include one or more sensors provided for measuring certain parameters related to machine 100 and providing corresponding parameter values. For example, physical sensor 140 may include physical emission sensors for measuring emissions of machine 100, such as Nitrogen Oxides (NOₓ), Sulfur Dioxide (SO₂), Carbon Monoxide (CO), total reduced Sulfur (TRS), etc. In particular, NOₓ emission sensing and reduction may be important to normal operation of engine 110. Physical sensor 142 may include any appropriate sensors that are used with engine 110 or other machine components (not shown) to provide various measured parameter values about engine 110 or other components, such as temperature, speed, acceleration rate, fuel pressure, power output, etc.

Virtual sensor network system 130 may be coupled with physical sensors 140 and 142 and ECM 120 to provide control functionalities based on integrated virtual sensors. A virtual sensor, as used herein, may refer to a mathematical algorithm or model that generates and outputs parameter values comparable to a physical sensor based on inputs from other systems, such as physical sensors 142. For example, a physical NOₓ emission sensor may measure the NOₓ emission level of machine 100 and provide parameter values of the NOₓ emission level to other components, such as ECM 120. A virtual NOₓ emission sensor may provide calculated parameter values of the NOₓ emission level to ECM 120 based on other measured or calculated parameters, such as compression ratios, turbocharger efficiencies, aftercooler characteristics, temperature values, pressure values, ambient conditions, fuel rates, engine speeds, etc. The term “virtual sensor” may be used interchangeably with “virtual sensor model.”

A virtual sensor network, as used herein, may refer to one or more virtual sensors integrated and working together to generate and output parameter values. For example, virtual sensor network system 130 may include a plurality of virtual sensors configured or established according to certain criteria based on a particular application. Virtual sensor network system 130 may also facilitate or control operations of the plurality of virtual sensors. The plurality of virtual sensors may include any appropriate virtual sensor providing output parameter values corresponding to one or more physical sensors in machine 100.

Further, virtual sensor network system 130 may be configured as a separate control system or, alternatively, may coincide with other control systems such as ECM 120. Virtual sensor network system 130 may also operate in series with or in parallel with ECM 120.

A server computer 150 may be coupled to machine 100, either onboard machine 100 or at an offline location. Server computer 150 may include any appropriate computer system configured to create, train, and validate virtual sensor models and/or virtual sensor network models. Server computer 150 may also deploy the virtual sensor models and/or the virtual sensor network models to virtual sensor network system 130 and/or ECM 120 if virtual sensor network system 130 coincides with ECM 120. Further, server computer 150 may communicate with virtual sensor network system 130 and/or ECM 120 to exchange operational and configuration data, such as information that may be used to detect and compensate for errors detected in physical sensors. Server computer 150 may communicate with virtual sensor network system 130 and/or ECM 120 via any appropriate communication means, such as a computer network or a wireless telecommunication link.

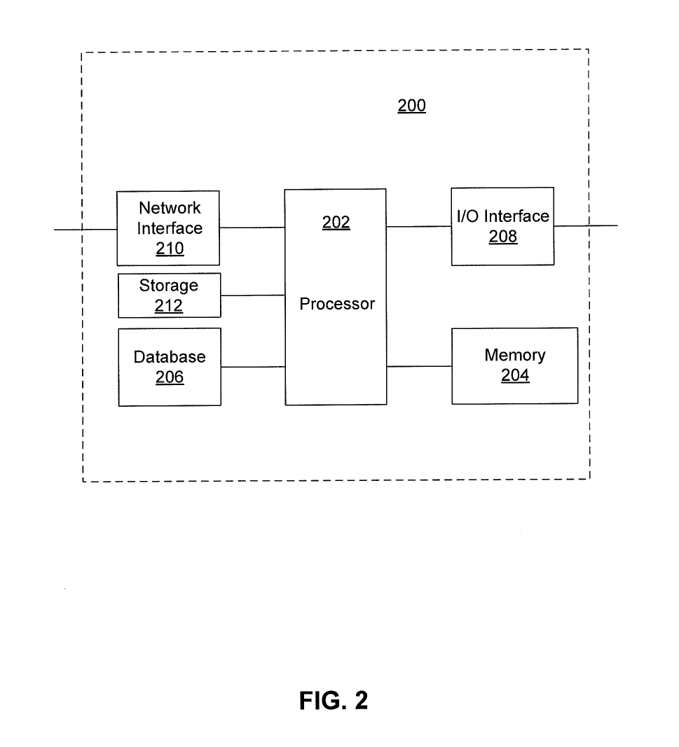

Virtual sensor network system 130 and/or ECM 120 may be implemented by any appropriate computer system. FIG. 2 shows an exemplary functional block diagram of a computer system 200 configured to implement virtual sensor network system 130 and/or ECM 120 and components thereof, such as sensor error detection as compensation system 121. Computer system 200 may also include server computer 150 configured to design, train, and validate virtual sensors in virtual sensor network system 130 and other components of machine 100.

As shown in FIG. 2, computer system 200 (e.g., virtual sensor network system 130, ECM 120, sensor error detection and compensation system 121, etc.) may include a processor 202, a memory 204, a database 206, an I/O interface 208, a network interface 210, and a storage 212. Other components, however, may also be included in computer system 200.

Processor 202 may include any appropriate type of general purpose microprocessor, digital signal processor, or microcontroller. Memory 204 may include one or more memory devices including, but not limited to, a ROM, a flash memory, a dynamic RAM, and a static RAM. Memory 204 may be configured to store information used by processor 202. Database 206 may include any type of appropriate database containing information related to virtual sensor networks, such as characteristics of measured parameters, sensing parameters, mathematical models, and/or any other control information. Storage 212 may include any appropriate type of storage provided to store any type of information that processor 202 may need to operate. For example, storage 212 may include one or more hard disk devices, optical disk devices, or other storage devices to provide storage space.

Memory 204, database 206, and/or storage 212 may also store information used to perform functions consistent with disclosed embodiments such as generating a physical sensor confidence value, determining an aggregated sensor value based on the physical sensor confidence value, the physical sensor output value, a virtual sensor output value received from a virtual sensor, and a virtual sensor confidence value, and determining whether the physical sensor has failed by comparing the physical sensor confidence value to a replacement threshold level.

I/O interface 208 may be configured to obtain data from input/output devices, such as various sensors or other components (e.g., physical sensors 140 and 142) and/or to transmit data to these components. Network interface 210 may include any appropriate type of network device capable of communicating with other computer systems based on one or more wired or wireless communication protocols. Any or all of the components of computer system 200 may be implemented or integrated into an application-specific integrated circuit (ASIC) or field programmable gate array (FPGA) device, or other integrated circuit devices.

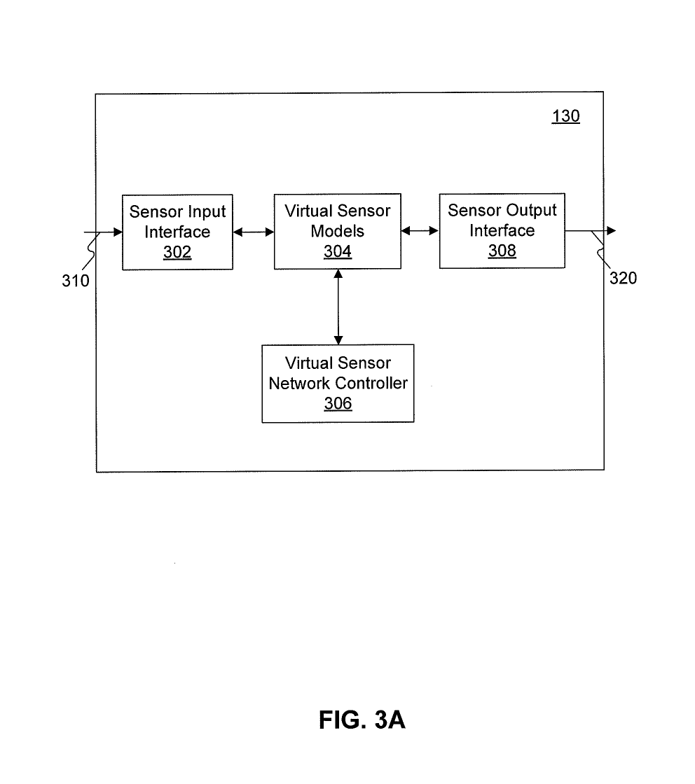

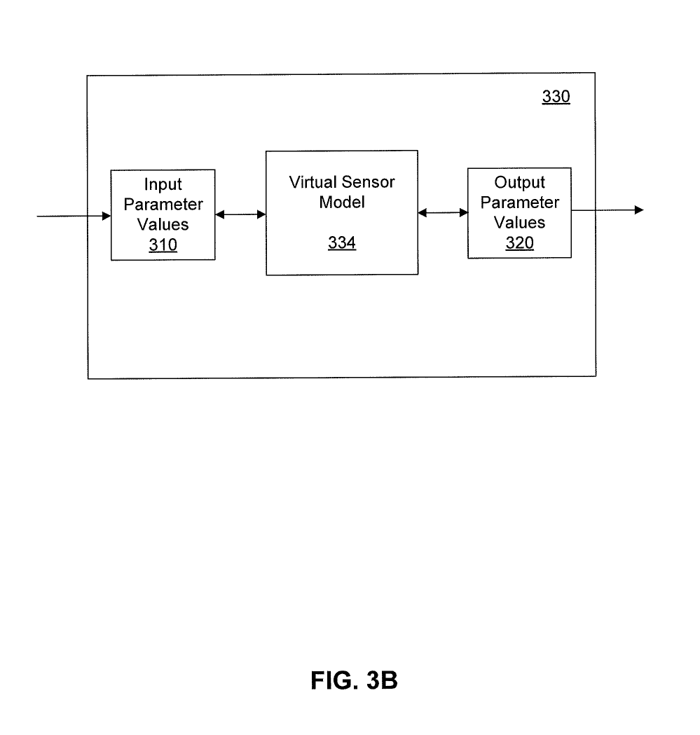

FIG. 3A shows a functional block diagram of virtual sensor network system 130 consistent with disclosed embodiments. As shown in FIG. 3A, virtual sensor network system 130 may include a sensor input interface 302, virtual sensor models 304, a virtual sensor network controller 306, and a sensor output interface 308. Input parameter values 310 are provided to sensor input interface 302 and output parameter values 320 are provided by sensor output interface 308.

Sensor input interface 302 may include any appropriate interface, such as an I/O interface or a data link configured to obtain information from various physical sensors (e.g., physical sensors 140 and 142) and/or from ECM 120. The information may include values of input or control parameters of the physical sensors, operational status of the physical sensors, and/or values of output parameters of the physical sensors. The information may also include values of input parameters from ECM 120 that may be sent to replace parameter values otherwise received from physical sensors 140 and 142. Further, the information may be provided to sensor input interface 302 as input parameter values 310.

Sensor output interface 308 may include any appropriate interface, such as an I/O interface or a datalink interface (e.g., an ECM/xPC interface), configured to provide information from virtual sensor models 304 and virtual sensor network controller 306 to external systems, such as ECM 120, or to an external user of virtual sensor network system 130, etc. The information may be provided to external systems and/or users as output parameter values 320.

Virtual sensor models 304 may include a plurality of virtual sensors, such as virtual emission sensors, virtual fuel sensors, virtual speed sensors, etc. Any virtual sensor may be included in virtual sensor models 304. FIG. 3B shows an exemplary virtual sensor 330 consistent with the disclosed embodiments.

As shown in FIG. 3B, virtual sensor 330 may include a virtual sensor model 334, input parameter values 310, and output parameter values 320. Virtual sensor model 334 may be established to link (e.g. build interrelationships) between input parameter values 310 (e.g., measured parameter values) and output parameter values 320 (e.g., sensing parameter values). After virtual sensor model 334 is established, input parameter values 310 may be provided to virtual sensor model 334 to generate output parameter values 320 based on the given input parameter values 310 and the interrelationships between input parameter values 310 and output parameter values 320 established by virtual sensor model 334.

In certain embodiments, virtual sensor 330 may be configured to include a virtual emission sensor to provide levels of substance emitted from an exhaust system (not shown) of engine 110, such as levels of nitrogen oxides (NOₓ), sulfur dioxide (SO₂), carbon monoxide (CO), total reduced sulfur (TRS), soot (i.e., a dark powdery deposit of unburned fuel residues in emission), hydrocarbon (HC), etc. For example, NOₓ emission level, soot emission level, and HC emission level may be important to normal operation of engine 110 and/or to meet certain environmental requirements. Other emission levels, however, may also be included.

Input parameter values 310 may include any appropriate type of data associated with NOₓ emission levels. For example, input parameter values 310 may be values of parameters used to control various response characteristics of engine 110 and/or values of parameters associated with conditions corresponding to the operation of engine 110. For example, input parameter values 310 may include values related to fuel injection timing, compression ratios, turbocharger efficiency, aftercooler characteristics, temperature (e.g., intake manifold temperature), pressure (e.g., intake manifold pressure), ambient conditions (e.g., ambient humidity), fuel rates, and engine speeds, etc. Other parameters, however, may also be included. For example, parameters originated from other vehicle systems, such as chosen transmission gear, axle ratio, elevation and/or inclination of the vehicle, etc., may also be included. Further, input parameter values 310 may be measured by certain physical sensors, such as physical sensor 142, and/or generated by other control systems such as ECM 120.

Virtual sensor model 334 may include any appropriate type of mathematical or physical model indicating interrelationships between input parameter values 310 and output parameter values 320. For example, virtual sensor model 334 may be a neural network based mathematical model that is trained to capture interrelationships between input parameter values 310 and output parameter values 320. Other types of mathematical models, such as fuzzy logic models, linear system models, and/or non-linear system models, etc., may also be used. Virtual sensor model 334 may be trained and validated using data records collected from a particular engine application for which virtual sensor model 334 is established. That is, virtual sensor model 334 may be established according to particular rules corresponding to a particular type of model using the data records, and the interrelationships of virtual sensor model 334 may be verified by using part of the data records.

After virtual sensor model 334 is trained and validated, virtual sensor model 334 may be optimized to define a desired input space of input parameter values 310 and/or a desired distribution of output parameter values 320. The validated or optimized virtual sensor model 334 may be used to produce corresponding values of output parameter values 320 when provided with a set of values of input parameter values 310. In the above example, virtual sensor model 334 may be used to produce NOₓ emission level based on measured parameters, such as ambient humidity, intake manifold pressure, intake manifold temperature, fuel rate, and engine speed, etc.

The establishment and operations of virtual sensor model 334 may be carried out by processor 202 based on computer programs stored at or loaded to virtual sensor network system 130. Alternatively, the establishment of virtual sensor model 334 may be realized by other computer systems, such as ECM 120 or a separate general purpose computer configured to create process models. The created process model may then be loaded to virtual sensor network system 130 for operations. For example, processor 202 may perform a virtual sensor process model generation and optimization process to generate and optimize virtual sensor model 334.

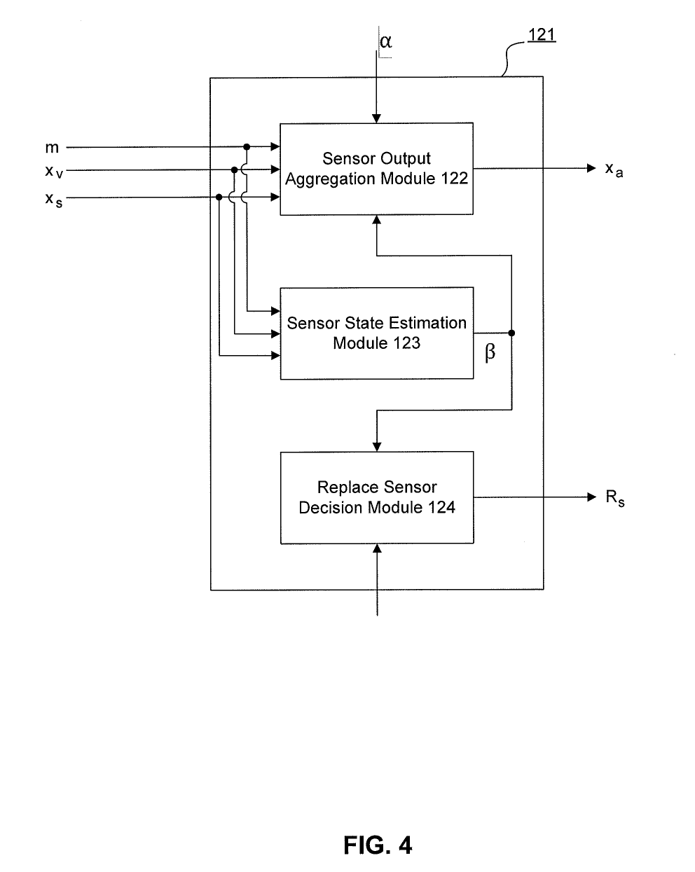

FIG. 4 shows an exemplary block diagram of sensor error detection and compensation system 121 which, as discussed above, may be included in ECM 120 or elsewhere as a part of or in communication with machine 100. Sensor error detection and compensation system 121 may receive a virtual sensor value xᵥ (e.g., an output parameter value), a corresponding virtual sensor confidence value m, and a physical sensor value xₛ. The virtual sensor value xᵥ may be determined by virtual sensor model 334, as described above. For example, the virtual sensor value xᵥ may be a NOₓ emissions value determined by virtual sensor model 334 based on input parameter values 310, and the physical sensor value xₛ may be a NOₓ emissions value measured directly by a physical emissions sensor, e.g., physical sensor 140. Sensor error detection and compensation system 121 may also determine an aggregated sensor value xₐ that represents a combination of the virtual sensor value xᵥ and physical sensor value xₛ and may output the aggregated sensor value xₐ to a control system, such as various components of ECM 120 in order to control machine 100 and/or engine 110. Sensor error detection and compensation system 121 may also output a replace physical sensor signal Rₛ that indicates whether physical sensor 140 has failed and should be replaced. It should be noted that “replacing” a physical sensor may include complete replacement of the sensor (i.e., removing the old physical sensor and introducing a new physical sensor) or servicing the existing physical sensor in some manner without complete replacement.

The virtual sensor confidence value m is an accuracy estimate of virtual sensor value xᵥ. Put another way, it is the confidence that sensor error detection and compensation system 121 has in the virtual sensor value xᵥ. The virtual sensor confidence value m may be calculated based on a comparison of the input parameter values 310 used by the virtual sensor 130 to determine virtual sensor value xᵥ to a range of input parameter values 310 that were used to train the virtual sensor 130. In one embodiment, a statistical analysis of the input parameter values 310 used to generate virtual sensor value xᵥ may be compared to a statistical analysis of the input parameter values 310 included in the training data set. For example, a Mahalanobis distance calculated for the input parameter values 310 used to generate virtual sensor value xᵥ may be compared to a valid range of Mahalanobis distances determined based on the training data set. The valid Mahalanobis distance range may be between 0 and a value that is three standard deviations from the mean of the Mahalanobis distances calculated for the input parameter values in the training data set. The virtual sensor confidence value m may then be calculated as a piecewise linear function, such that a virtual sensor value xᵥ with input parameter values at the mean of the training data set (e.g., with MDᵢ=0) has a virtual sensor confidence value m of 1.00, a virtual sensor value xᵥ with input parameter values with MDᵢ≧3σ has a virtual sensor confidence value m of 0.00, and a linear function from a point (0, 1.00) to a point (3σ, 0.00) represents the virtual sensor confidence value m for all output values with input parameter values having corresponding Mahalanobis distances between MDᵢ=0 and MDᵢ=3σ. Of course, other upper and lower bounds may be used as may any other non-linear functions.

As shown in FIG. 4, sensor error detection and compensation system 121 may include a sensor output aggregation module 122, a sensor state estimation module 123, and a replace sensor decision module 124. While FIG. 4 shows sensor error detection and compensation system 121 as including the separate modules discussed above, those skilled in the art will appreciate that these modules may be implemented as software stored in a memory and/or storage and executed by a processor to enable sensor error detection and compensation system 121 to perform functions consistent with disclosed embodiments. For example, sensor error detection and compensation system 121 may include one or more processors, memories, storages, and input/output interfaces of ECM 120 as shown in FIG. 2.

Sensor output aggregation module 122 aggregates the virtual sensor value xᵥ and the physical sensor value xₛ, to provide the aggregated sensor value xₐ. As discussed, the aggregated sensor value xₐ is designated as the current output of the parameter being monitored (e.g., NOₓ emissions) and supplied to a control system, such as a part of ECM 120, to determine a particular action to be taken (e.g., a recommended cleansing action to reduce NOₓ emissions). In addition to the sensor values xᵥ and xₛ and virtual sensor confidence value m, sensor output aggregation module 122 receives a physical sensor confidence value β that is provided by sensor state estimation module 123. Sensor output aggregation module 122 also receives an attitudinal character parameter α which is discussed in greater detail below and may be configured by a user.

The sensor state estimation module 123 generates the physical sensor confidence value β. The physical sensor confidence value β is a measure of confidence in the current reading supplied by the physical sensor and is between 0 and 1. In particular, a higher β value indicates a greater confidence in the value provided by the physical sensor.

The replace sensor decision module 124 determines whether to replace the physical sensor. As will be discussed in greater detail below, as physical sensor 140 begins to decay, indicated by a lowering of the confidence value β, the aggregated sensor value xₐ becomes less dependent on the physical sensor. Further, the replace sensor decision module 124 compares the confidence value β to a replacement threshold level γ to determine whether physical sensor 140 should be replaced. The operation of the three modules included in sensor error detection and compensation system 121 are now discussed in greater detail.

In certain embodiments, sensor output aggregation module 122 calculates and outputs the aggregated sensor value xₐ as an ordered weighted average (OWA) of the virtual sensor value xᵥ and the physical sensor value xₛ. In general, an OWA aggregator F aggregates a collection of argument values, a₁, a₂, . . . , aₙ using a collection of weights w₁, w₂, . . . , wₙ such that:

$$F ( {a}_{1} , {a}_{2} , … , {a}_{n} ) = {\sum }_{j = 1}^{n} {w}_{j} {b}_{j} \qquad ( 1 )$$

where bⱼ is the jth largest of the argument values aᵢ, and the OWA weights wⱼ satisfy 0≦wⱼ≦1 and Σⱼ wⱼ=1. The selection of the weights determines the type of aggregation that will be performed. For example, if w₁=1, and all other wⱼ=0, then this results in selecting the largest argument value, such that F(a₁, a₂, . . . , aₙ)=Maxᵢ[aᵢ]. If wₙ=1, and all other wⱼ=0, then this results in selecting the minimum argument value such that F(a₁, a₂, . . . , aₙ)=Minᵢ[aᵢ]. And, if all wⱼ=1/n then this gives the simple average, F(a₁, a₂, . . . , aₙ) is simply the average of the arguments. Moreover, an attitudinal character parameter α may be used to allow a user to emphasize certain arguments over others. For example, an attitudinal character parameter α may be defined as:

$$α = {\sum }_{j = 1}^{n} {w}_{j} \frac{n - j}{n - 1} \qquad ( 2 )$$

for all wⱼ. As can be seen from equation (2), when the aggregation is a maximum type w₁=1, then α=1, when the aggregation is a minimum type, wₙ=1, then α=0, and when the aggregation is an average of all arguments, then α=0.5. Thus, by selecting the attitudinal character parameter α, a user may emphasize larger or smaller arguments (e.g., sensor readings) over others.

In embodiments where sensor output aggregation module 122 calculates and outputs aggregated sensor value xₐ based on virtual sensor value xᵥ and physical sensor value xₛ, the two arguments to the OWA aggregator are xᵥ and xₛ. Moreover, the relative weights used in the OWA aggregator to aggregate the virtual sensor value xᵥ and physical sensor value xₛ to produce the aggregated sensor value xₐ may be determined based on the attitudinal character parameter α and the virtual and physical sensor confidence values m and β. For example, sensor output aggregation module 122 may calculate aggregated sensor value xₐ as:

xₐ=(μ^{G}b₁)+((1−μ^{G})b₂) (3)

where μ is a relative confidence value defined as:

$$μ = \{ \frac{β}{( β + m )} \vert {x}_{s} >= {x}_{v} \} \\ μ = \{ \frac{m}{( β + m )} \vert {x}_{v} > {x}_{s} \} \qquad ( 4 )$$

and G is a disagreement bias that is a function of the attitudinal character parameter α and defined as:

$$G = \frac{1 - α}{α} \qquad ( 5 )$$

Moreover, as discussed above, b₁ is the larger argument and b₂ is the smaller argument, and thus, b₁ is the larger of xₛ and xᵥ and b₂ is the smaller of the two. Thus, the aggregated sensor value xₐ is a weighted average of the virtual sensor value xᵥ and physical sensor value xₛ that takes into account the attitudinal character parameter α and the virtual and physical sensor confidence values m and β.

As discussed above, attitudinal character parameter α may be defined by a user or engineer associated with machine 100. For example, if the user chooses α=0, then xₐ will be equal to the lower of the two values of xₛ and xᵥ. Conversely, if the user chooses α=1, then xₐ will be equal to the higher of the two values of xₛ and xᵥ. Different values of α may be chosen to emphasize one value over another. For example, in embodiments where the sensors are NOₓ sensors, a value of α may be chosen to be between 0.5 and 1.0 such that the sensor output with the larger NOₓ value is emphasized. The system may be configured in this way to avoid emissions that inadvertently exceed limits or thresholds, for example.

Sensor state estimation module 123 may receive the virtual sensor value xᵥ, the physical sensor value xₛ, and the virtual sensor confidence value m, and may generate the physical sensor confidence value β by comparing the outputs of the physical sensor with those of the virtual sensor. In certain embodiments, sensor state estimation module 123 may compare the values at several different times and may determine that those comparisons where the virtual sensor confidence value m is high are to be assigned greater weight than those comparisons where the virtual sensor confidence value m is low. Sensor state estimation module 123 may send the generated physical sensor confidence value β to one or more of sensor error detection and compensation system 121 and sensor state estimation module 123.

In an exemplary embodiment, sensor state estimation module 123 may compare multiple physical sensor values xs to multiple corresponding virtual sensor values xᵥ in a time series of physical sensor values xₛ, virtual sensor values xᵥ, and virtual sensor confidence values m. For example, xᵥ(i) is the virtual sensor value on the ith observation, xₛ(i) is the physical sensor value on the ith observation, and m(i) is the virtual sensor confidence value on the ith observation. For each reading in the time series, sensor state estimation module 123 may calculate an effective normalized sensor reading difference d(i). The calculation of d(i) is discussed in greater detail below. Sensor state estimation module 123 may also calculate a current weighted average D(i) of the different d(i) values, such that:

$$D ( i ) = \frac{{\sum }_{t = 1}^{i} d ( t ) m ( t )}{{\sum }_{t = 1}^{i} m ( t )} \qquad ( 6 )$$

Thus, D(i) represents a weighted average of the effective normalized sensor reading differences d(t) that is weighted by the virtual sensor confidence values m(t). This way, the bigger m(t), the more confident the system is in the readings from the virtual sensor and the more it contributes to the determination of the current weighted average D(i).

Sensor state estimation module 123 may use the current weighted average D(i) to determine the current physical sensor confidence value β. For example, sensor state estimation module 123 may determine the current physical sensor confidence value β to be:

$$β = \{ \begin{matrix}1 & if D ( i ) \leq {r}_{1} \\ \frac{{r}_{2} - D ( i )}{{r}_{2} - {r}_{1}} & if {r}_{1} < D ( i ) < {r}_{2} \\ 0 & if D ( i ) \geq {r}_{2}\end{matrix} \qquad ( 7 )$$

where r₁ and r₂ are threshold values that may be determined by a user, e.g., based on parameters of the physical sensor. For example, r₂ may be chosen to be a value at which the user determines that the physical sensor is completely unreliable.

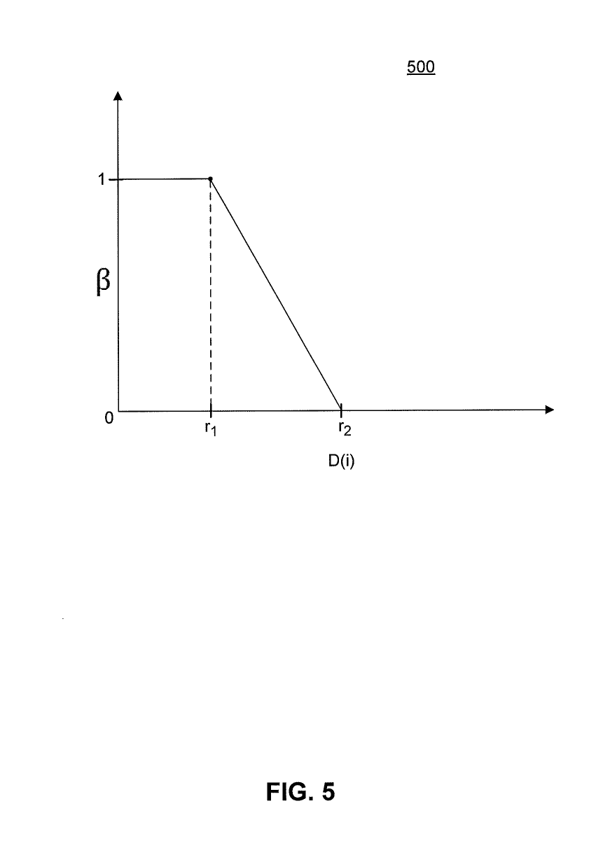

FIG. 5 shows a graph 500 of the relationship between the current physical sensor confidence value β and the current weighted average D(i). For example, as shown in graph 500, current physical sensor confidence value β is equal to 1 when D(i) is between 0 and r₁, then decreases at a slope of 1/(r₁−r₂) when D(i) is between r₁ and r₂, and is equal to 0 when D(i) is greater than or equal to r₂. Thus, the physical sensor confidence value β is not immediately discounted based on some observation of error in d(i), but is instead maintained at 1 for a range of 0 to r₁. The range of 0 to r₁ may thus represent a range of measurement variation that would be expected when the physical sensor is working as intended.

As discussed above, sensor state estimation module 123 may calculate an effective normalized sensor reading difference d(i) to generate the current weighted average D(i) value that is in turn used to calculate current physical sensor confidence value β. To do so, sensor state estimation module 123 may determine a sensor reading difference value Δ(i) such that

$$Δ ( i ) = \{ \begin{matrix}0 & if ranges overlap \\ {x}_{s}^{low} ( i ) - {x}_{v}^{high} ( i ) & if no overlap and {x}_{s} ( i ) > {x}_{v} ( i ) \\ {x}_{v}^{high} ( i ) - {x}_{s}^{low} ( i ) & if no overlap and {x}_{v} ( i ) \geq {x}_{s} ( i )\end{matrix} \qquad ( 8 )$$

where x^{high} and x^{low} represent the high and low bounds of the confidence range for the corresponding physical or virtual sensor. These ranges may be determined, for example, based on empirical considerations about the performance of the virtual sensor 130 and the error sensitivity of the physical sensor. For example, confidence ranges may be established for different readings of virtual sensor 130 for different virtual sensor outputs during the training and calibration of virtual sensor 130. Confidence ranges may be established for physical sensor 140 based on known characteristics of the physical sensor, e.g., from specifications provided by a manufacturer. For example, if the manufacturer's specification states that the physical sensor is accurate within 2% for a physical sensor reading xₛ(i), then the confidence range may be between 0.98xₛ(i) and 1.02xₛ(i). In other words, xₛ^{low}(i) may be 0.98xₛ(i) and xₛ^{high}(i) may be 1.02xₛ(i). If percentage accuracies are known for virtual sensor 130, e.g., based on a statistical analysis of the training data set, then the confidence ranges of the virtual sensor may be calculated in a similar manner.

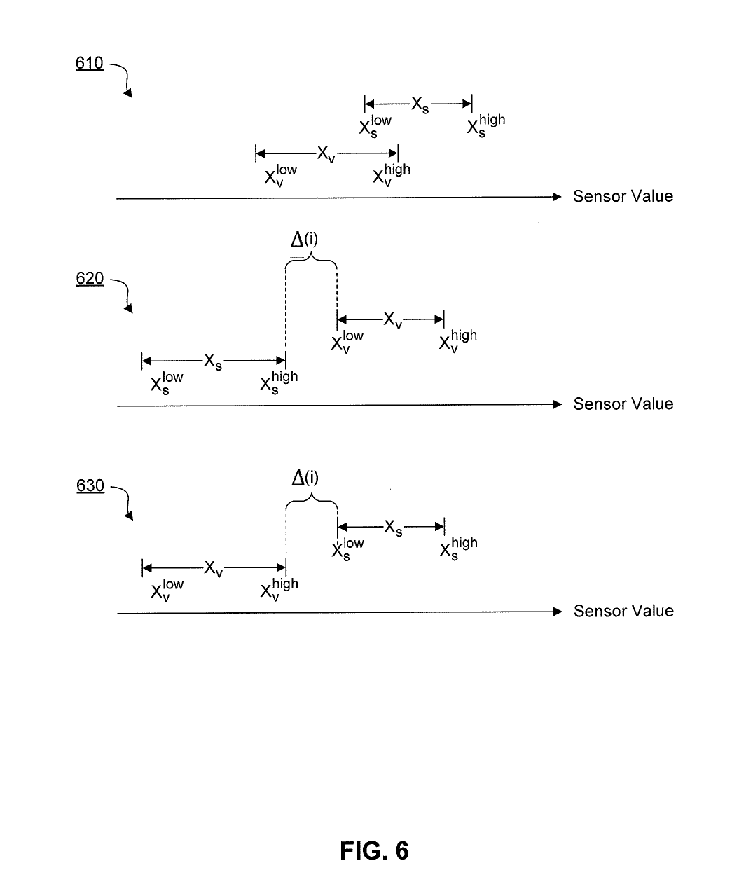

FIG. 6 illustrates three graphs 610, 620, and 630 that illustrate three scenarios for determining the sensor reading difference value Δ(i). For example, in graph 610 the confidence ranges of xₛ and xᵥ overlap, thus, Δ(i)=0. While graph 610 shows xₛ>xᵥ, those skilled in the art will appreciate that Δ(i) is also 0 in the other scenario where xᵥ>xₛ, as long as the confidence ranges still overlap. In graph 620, the confidence ranges do not overlap and xᵥ>xₛ. Thus, Δ(i) is the difference between the low end of the confidence range for virtual sensor 130 and the high end of the confidence range for physical sensor 140. In graph 630, the confidence ranges do not overlap and xₛ>xᵥ. Thus, Δ(i) is the difference between the low end of the confidence range for physical sensor 140 and the high end of the confidence range for virtual sensor 130.

After calculating the sensor reading difference value Δ(i), sensor state estimation module 123 may calculate the effective normalized sensor reading difference d(i) as:

$$d ( i ) = \frac{Δ ( i )}{Max [ {x}_{v} ( i ) , {x}_{s} ( i ) ]} \qquad ( 9 )$$

Thus, in this case, d(i) is in the non-negative unit interval (i.e., always between 0 and 1).

Sensor state estimation module 123 may then calculate the value of D(i) in accordance with equation (6), discussed above, which may then be used to calculate the current physical sensor confidence value β in accordance with equation (7), discussed above.

In certain of the embodiments discussed above, it may be assumed that the current physical sensor confidence value β remains constant over the time interval of the time series. However, the current physical sensor confidence value β may slowly change over time, e.g., as physical sensor 140 deteriorates. Thus, sensor state estimation module 123 may also discount earlier readings in the time series, e.g., using a windowing method or an exponential smoothing method. In one embodiment, sensor state estimation module 123 may implement exponential smoothing using a two step process of first exponentially smoothing the estimates of the virtual sensor confidence value m and then determining the exponentially smoothed estimate of the current weighted average D(i) in accordance with the two equations shown below:

$$\begin{matrix}\overline{m} ( i ) = \overline{m} ( i - 1 ) + δ ( m ( i ) - \overline{m} ( i - 1 ) ) & ( 10 ) \\ D ( i ) = δ \frac{m ( i )}{\overline{m} ( i )} d ( t ) + ( 1 - δ ) \frac{\overline{m} ( i - 1 )}{\overline{m} ( i )} D ( i - 1 ) & ( 11 )\end{matrix}$$

where m̅(i) and m̅(i−1) are the new and previous exponentially smoothed estimates of virtual sensor confidence value m, and D(i) and D(i−1) are the new and previously exponentially smoothed estimates for the current weighted average D. The value δ is the smoothing constant and is between 0 and 1. Using these algorithms, sensor state estimation module 123 may provide an estimate for D(i) that can be used to determine the slowly changing value for β while also taking into account the different credibility metrics of each reading.

Replace sensor decision module 124 uses the physical sensor confidence value β and the replacement threshold level γ to determine whether physical sensor 140 has failed and should be replaced. The replacement threshold level γ may be a value between 0 and 1 and may be configured by a user of machine 100 or a person otherwise associated with machine 100 based on the amount of certainty required before declaring sensor failure. For example, a replacement threshold level γ of 0 may require near certainty before determining that physical sensor 140 has failed. On the other hand, a replacement threshold level γ of 1 may cause replace sensor decision module 124 to determine that physical sensor 140 has failed based on any evidence whatsoever of a physical sensor failure. Thus, by adjusting the replacement threshold level γ a user may be able to configure the sensitivity of replace sensor decision module 124.

In certain embodiments, replace sensor decision module 124 may determine that physical sensor 140 has failed if β<γ and may determine that physical sensor 140 has not failed if β≧γ. Upon determining that physical sensor 140 has failed, replace sensor decision module 124 may output a replace physical sensor signal Rₛ, e.g., to a part of ECM 120 or to some other control system. Thus, sensor error detection and compensation system, through sensor output aggregation module 122 and replace sensor decision module 124, may be configured to diagnose and inform of a fail soft condition of physical sensor 140 (e.g., via replace physical sensor signal Rₛ) and simultaneously correct the sensed parameter being sent to the control system (e.g., via an aggregated sensor value xₐ). Further, in cases where β<γ and sensor replacement is recommended by decision module 124, xₐ may be completely determined by xᵥ, xᵥ^{high}, or xᵥ^{low} until such time as the replacement is complete. The choice of xᵥ, xᵥ^{high}, or xᵥ^{low} may be determined by the desired response to a sensor failure for the system in question.

### INDUSTRIAL APPLICABILITY

The disclosed sensor error detection and compensation system may be applicable to any system used to monitor and/or control a machine that includes both virtual and physical sensors. In particular, the virtual sensor system may be applicable to a control system for controlling an engine and monitoring emissions from the engine. Moreover, using one or more exemplary processes disclosed herein the sensor error detection and compensation system may be capable of diagnosing a fail soft condition of a physical sensor and simultaneously correcting the sensed parameter being sent to the control system.

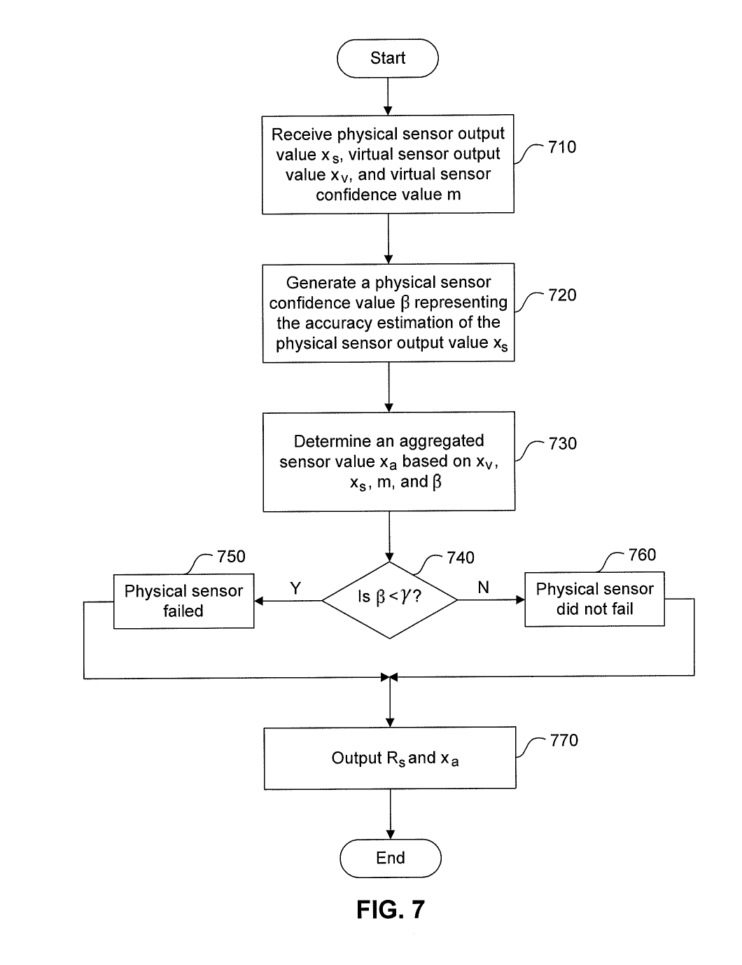

FIG. 7 shows an exemplary process that may be performed by sensor error detection and compensation system 121 to provide data to ECM 120 that ECM 120 may use to control engine 110. As shown in FIG. 7, error detection and compensation system 121 may receive physical sensor output value xₛ, virtual sensor output value xᵥ, and virtual sensor confidence value m corresponding to virtual sensor output value xᵥ (step 710). For example, as shown in FIG. 4, sensor output aggregation module 122 and sensor state estimation module 123 may receive these three values.

Error detection and compensation system 121 may generate a physical sensor confidence value β (step 720). The physical sensor confidence value β may represent the accuracy estimation of the physical sensor output value xₛ or, in other words, the confidence that sensor error detection and compensation system 121 has in the physical sensor output value xₛ. Sensor state estimation module 123 may generate the physical sensor confidence value β based on a comparison of a time series of the values xᵥ, xₛ, and m, as discussed above.

Sensor error detection and compensation system 121 may use the physical sensor confidence value β as well as the values xᵥ, xₛ, m to determine an aggregated sensor value xₐ (step 730). For example, sensor output aggregation module 122 may determine the aggregated sensor value xₐ using one or more processes discussed above, such as determining an OWA of the values xᵥ and xₛ where the weighting values are determined based on the values m and β.

Sensor error detection and compensation system 121 may also compare the physical sensor confidence value β to a replacement threshold level γ that may be user-defined in order to determine whether the physical sensor has failed and should be replaced (step 740). If β<γ (step 740, Y), then sensor error detection and compensation system 121 may determine that the physical sensor has failed and should be replaced (step 750). If β≧γ (step 740, N), then sensor error detection and compensation system 121 may determine that the physical sensor has not failed and does not need to be replaced (step 760).

Sensor error detection and compensation system 121 may also output the aggregated sensor value xₐ and an indication of whether the sensor needs to be replaced, e.g., via replace physical sensor signal Rₛ, to a control system that controls machine 100 (step 770). The process of FIG. 7 may be repeated each time new output values are received from physical sensor 140 and virtual sensor 130. Thus, after step 770, sensor error detection and compensation system 121 may return to step 710 and receive subsequent sensor output values xₛ and xᵥ and corresponding virtual sensor confidence value m and repeat the process shown in FIG. 7.

It will be apparent to those skilled in the art that various modifications and variations can be made to the disclosed sensor error detection and compensation system. Other embodiments will be apparent to those skilled in the art from consideration of the specification and practice of the disclosed sensor error detection and compensation system. It is intended that the specification and examples be considered as exemplary only, with a true scope being indicated by the following claims and their equivalents.

What is claimed is:

1. A sensor error detection and compensation system comprising:
a memory configured to store instructions; and
a processor configured to execute the instructions to:
generate a physical sensor confidence value representing an accuracy estimation of a physical sensor output value received from a physical sensor;
determine an aggregated sensor value based on the physical sensor confidence value, the physical sensor output value, a virtual sensor output value received from a virtual sensor, and a virtual sensor confidence value representing an accuracy estimation of the virtual sensor output value;
determine whether the physical sensor has failed by comparing the physical sensor confidence value to a replacement threshold level; and
output the aggregated sensor value and an indication of whether the physical sensor has failed to a control system of a machine.

2. The sensor error detection and compensation system of claim 1, the processor being further configured to:
determine the aggregated sensor value to be a weighted average of the physical sensor output value and the virtual sensor output value.

3. The sensor error detection and compensation system of claim 2, wherein weighting values in the weighted average used to determine the aggregated sensor value are based on the physical sensor confidence value and the virtual sensor confidence value.

4. The sensor error detection and compensation system of claim 3, wherein the weighting values are further based on an attitudinal character value that is defined by a user.

5. The sensor error detection and compensation system of claim 1, wherein
the physical sensor output value is a NOₓ emissions level and the virtual sensor output value is a NOₓ emissions level, and
the aggregated sensor value determined by the processor is a NOₓ emissions level.

6. The sensor error detection and compensation system of claim 1, the processor being further configured to:
determine the physical sensor confidence value based on a weighted average of effective normalized sensor reading differences between a time series of physical sensor output values and a time series of corresponding virtual sensor output values.

7. The sensor error detection and compensation system of claim 6, the processor being further configured to:
determine the physical sensor confidence value based on a comparison of the weighted average of the effective normalized sensor reading differences to at least one threshold value.

8. The sensor error detection and compensation system of claim 1, wherein
the replacement threshold level is defined by a user; and
the processor is further configured to:
determine that the physical sensor has failed if the physical sensor confidence value is less than the replacement threshold level; and
determine that the physical sensor has not failed if the physical sensor confidence value is greater than or equal to the replacement threshold level.

9. A sensor error detection and compensation method comprising:
generating, by one or more processors, a physical sensor confidence value representing an accuracy estimation of a physical sensor output value received from a physical sensor;
determining, by the one or more processors, an aggregated sensor value based on the physical sensor confidence value, the physical sensor output value, a virtual sensor output value received from a virtual sensor, and a virtual sensor confidence value representing an accuracy estimation of the virtual sensor output value;
determining whether the physical sensor has failed by comparing the physical sensor confidence value to a replacement threshold level; and
outputting the aggregated sensor value and an indication of whether the physical sensor has failed to a control system of a machine.

10. The sensor error detection and compensation method of claim 9, further including:
determining the aggregated sensor value to be a weighted average of the physical sensor output value and the virtual sensor output value.

11. The sensor error detection and compensation method of claim 10, wherein weighting values in the weighted average used to determine the aggregated sensor value are based on the physical sensor confidence value and the virtual sensor confidence value.

12. The sensor error detection and compensation method of claim 11, wherein the weighting values are further based on an attitudinal character value that is defined by a user.

13. The sensor error detection and compensation method of claim 9, wherein
the physical sensor output value is a NOₓ emissions level and the virtual sensor output value is a NOₓ emissions level, and
the aggregated sensor value is a NOₓ emissions level.

14. The sensor error detection and compensation method of claim 9, further including:
determining the physical sensor confidence value based on a weighted average of effective normalized sensor reading differences between a time series of physical sensor output values and a time series of corresponding virtual sensor output values.

15. The sensor error detection and compensation method of claim 14, further including:
determining the physical sensor confidence value based on a comparison of the weighted average of the effective normalized sensor reading differences to at least one threshold value.

16. The sensor error detection and compensation method of claim 9, further including:
determining that the physical sensor has failed if the physical sensor confidence value is less than the replacement threshold level; and
determining that the physical sensor has not failed if the physical sensor confidence value is greater than or equal to the replacement threshold level.

17. A sensor error detection and compensation system comprising:
a sensor state estimation module configured to generate a physical sensor confidence value representing an accuracy estimation of a physical sensor output value received from a physical sensor;
a sensor output aggregation module configured to determine an aggregated sensor value based on the physical sensor confidence value, the physical sensor output value, a virtual sensor output value received from a virtual sensor, and a virtual sensor confidence value representing an accuracy estimation of the virtual sensor output value; and
a replace sensor decision module configured to determine whether the physical sensor has failed by comparing the physical sensor confidence value to a replacement threshold level.

18. The sensor error detection and compensation system of claim 17, the sensor output aggregation module being further configured to determine the aggregated sensor value to be a weighted average of the physical sensor output value and the virtual sensor output value.

19. The sensor error detection and compensation system of claim 18, wherein weighting values in the weighted average used to determine the aggregated sensor value are based on the physical sensor confidence value and the virtual sensor confidence value.

20. The sensor error detection and compensation system of claim 17, wherein
the physical sensor output value is a NOₓ emissions level and the virtual sensor output value is a NOₓ emissions level, and
the aggregated sensor value determined by the processor is a NOₓ emissions level.
